(19) United States
(12) Patent Application Publication
(10) Pub. No.: US 2024/0202127 A1
(43) Pub. Date: Jun. 20, 2024

(54) SIDEBAND INSTRUCTION ADDRESS TRANSLATION

(71) Applicant: International Business Machines Corporation, Armonk, NY (US)

(72) Inventors: Bryan Lloyd, Austin, TX (US); David A. Hrusecky, Cedar Park, TX (US); Richard J. Eickemeyer, Rochester, MN (US); Mohit Karve, Austin, TX (US); Dung Q. Nguyen, Austin, TX (US); Nicholas R. Orzol, Austin, TX (US); Sheldon Bernard Levenstein, Austin, TX (US); Naga P. Gorti, Austin, TX (US)

(21) Appl. No.: 18/066,480

(22) Filed: Dec. 15, 2022

(51) Int. Cl. G06F 12/0875; G06F 9/30; G06F 9/38

(52) U.S. Cl. CPC G06F 12/0875; G06F 9/30043; G06F 9/3802; G06F 2212/452

(57) ABSTRACT

Embodiments relate to sideband instruction address translation. According to an aspect, a computer-implemented method includes managing, within a processor, an instruction effective-to-real-address table (I-ERAT) separate from a main ERAT, where the I-ERAT has a smaller storage capacity than the main ERAT. The method also includes indicating an I-ERAT hit based on determining that an instruction address for an instruction cache is stored in the I-ERAT, bypassing an arbitrator within the processor and sending a translated address from the I-ERAT to the instruction cache based on detecting the I-ERAT hit, and sending an address translation request through the arbitrator to the main ERAT based on an I-ERAT miss and writing a translation result of the main ERAT to the I-ERAT.

### BACKGROUND

The present invention generally relates to computer systems, and more specifically, to computer-implemented methods, computer systems, and computer program products configured and arranged to perform sideband instruction address translation.

In computing environments that have multi-core processor chips, multiple threads can be supported per processor core. Separate caches can be used for instructions (I-cache) and for data (D-cache). I-cache and D-cache can use address translation to support virtual addressing such that executable code can be ported to different regions of memory and need not be tied to fixed physical (i.e., real) addresses. Address translation can be performed using an effective-to-real-address table (ERAT). The process of performing an address lookup operation can be time consuming, where multiple clock cycles may be needed. Where multiple threads are supported, there can be a substantial amount of address translation. When the ERAT is shared by multiple units within a processor, there can be delays that reduce processing throughput due to arbitration between the units.

### SUMMARY

Embodiments of the present invention are directed to computer-implemented methods for sideband instruction address translation. A computer-implemented method includes managing, within a processor, an instruction effective-to-real-address table (I-ERAT) separate from a main ERAT, where the I-ERAT has a smaller storage capacity than the main ERAT. The method also includes indicating an I-ERAT hit based on determining that an instruction address for an instruction cache is stored in the I-ERAT, bypassing an arbitrator within the processor and sending a translated address from the I-ERAT to the instruction cache based on detecting the I-ERAT hit, and sending an address translation request through the arbitrator to the main ERAT based on an I-ERAT miss and writing a translation result of the main ERAT to the I-ERAT.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a high-level component diagram of an illustrative example of a system according to one or more embodiments of the present invention;

FIG. 2 depicts a schematic diagram illustrating a symmetric multi-core processing system according to one or more embodiments of the present invention;

FIG. 3 depicts an example block diagram of a system for address translation within a processor according to one or more embodiments of the present invention;

FIG. 4 depicts an example block diagram of a system for address translation within a processor according to one or more embodiments of the present invention;

FIG. 5 depicts a flow diagram of a method according to one or more embodiments of the present invention; and

FIG. 6 depicts a block diagram of an example computing environment for use in conjunction with one or more embodiments of the present invention.

### DETAILED DESCRIPTION

Various technical benefits and technical solutions are provided by techniques, processes, devices, and systems for improving throughput efficiency in address translation within a processor. The use of an instruction effective-to-real-address table (I-ERAT) separate from a main ERAT can provide a sideband path, where address translations already present in the I-ERAT can be used to bypass arbitration and use of the main ERAT. The main ERAT can have a larger storage capacity than the I-ERAT and is shared by multiple units within a processor. Further internal storage and timing efficiencies may be achieved where the I-ERAT is distributed between multiple units within the processor. The split of the I-ERAT can reduce redundant information storage and input/output (I/O) across functional unit boundaries within the processor. The use of the I-ERAT with the main ERAT can be beneficial, for instance, when performing address translation to a level-2 instruction cache. Pipeline timing can be configured to match read and write times for I-ERAT entries distributed between functional units to avoid delay penalties and ensure table integrity.

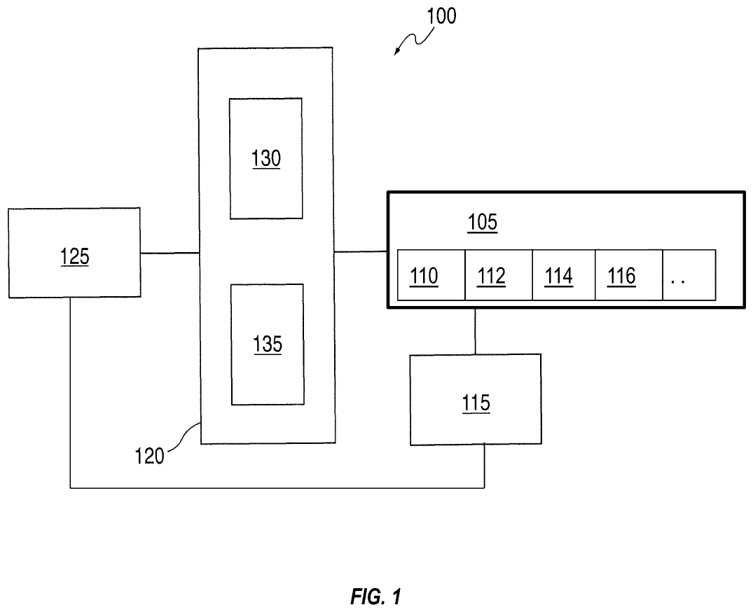

Turning to the drawings, FIG. 1 depicts a system 100 as an example of a computer system. The system 100 includes a central processor or central processing unit (CPU) 105, also referred to as processor 105. The processor 105 may include any suitable components, such as an instruction fetch unit (IFU) 110, and may be coupled in communication with a memory subsystem 115.

The IFU 110 can be employed to fetch instructions on behalf of the processor 105 from memory subsystem 115. The IFU 110 can fetch “next sequential instructions”, target instructions of branch taken instructions, or first instructions of a program following a context switch. As one example, IFU 110 can employ prefetch techniques to speculatively prefetch instructions based on the likelihood that the prefetched instructions might be used. For example, the IFU 110 can fetch 16 bytes of instructions that include the next sequential instruction and additional bytes of further sequential instructions. The fetched instructions are decoded to determine the nature of these instructions and then are dispatched.

In one or more examples, the dispatched instruction(s) are passed to an instruction sequencing unit (ISU) 112. The ISU 112 can forward information about the decoded instruction(s) when issuing instructions to appropriate units of the processor 105. In some examples, the ISU 112 can support out-of-order execution of instructions by maintaining register renames, instruction dependencies while adhering to program order. An instruction unit can determine which instructions are ready to be issued. Issued instructions are then executed by the processor 105 in corresponding units in the back end.

For example, the processor 105 can include an execution unit 116 that receives information about issued arithmetic instructions from the ISU 112 and performs arithmetic operations on operands according to the opcode of the instruction. Operands of such instructions are provided to the execution unit 116 from memory subsystem 115, architected registers of the processor 105, and/or from an immediate field of the instruction being executed. Results of the execution, when stored, can be stored in memory subsystem 115, architected registers, and/or in other machine hardware (such as control registers, status registers and the like).

As another example, the processor 105 also includes a load store unit (LSU) 114. The LSU 114 can access data operands in memory subsystem 115. The LSU 114 can perform a memory load operation by obtaining the address of the target operand and loading the content at the corresponding memory location into a register or another memory location. The LSU 114 can perform a store operation by obtaining the address of the target operand and storing data obtained from a register or another memory location into the target operand location in memory. In one or more examples, the LSU 114 can be speculative and may access memory in a sequence that is out-of-order relative to program order; however, the LSU 114 maintains the appearance of overall data consistency as seen by programs.

In an example where processor 105 is an out-of-order superscalar processor, the ISU 112 can communicate with components of the processor 105, such as IFU 110, LSU unit 114, execution unit 116, registers, cache/memory interface or other elements of the processor 105, including various register circuits and other arithmetic logic units (ALUs), to provide pipeline sequencing to keep operations in-order. While instructions may be executed out of order, but the ISU 112, together with other units in processor 105, provides functionality to make the out-of-order operations appear to the program as having been performed in order.

The system 100 can include multiple levels of caches or other such structures that provide a source of instructions and data with lower latencies from memory subsystem 115 in addition to (or in place of) the direct connection between processor 105 and memory subsystem 115. For instance, the system 100 can include a first-level cache 120 and a second-level cache 125 that supports the first-level cache 120. The second-level cache 125 can work with memory subsystem 115 in retrieving and updating contents in memory. The first-level cache 120 can include an instruction cache (I-cache) 130 and a data cache (D-cache) 135. Other caching structures or topologies can be deployed in system 100, not illustrated, by those skilled in the art, but should not affect the present invention. Although depicted separately, the first-level cache 120 and the second-level cache 125 can be incorporated in the processor 105. For example, the processor 105 can incorporate one or more cores with pipelines including the units 110-116, first-level cache 120, and the second-level cache 125 as a multi-core processor chip.

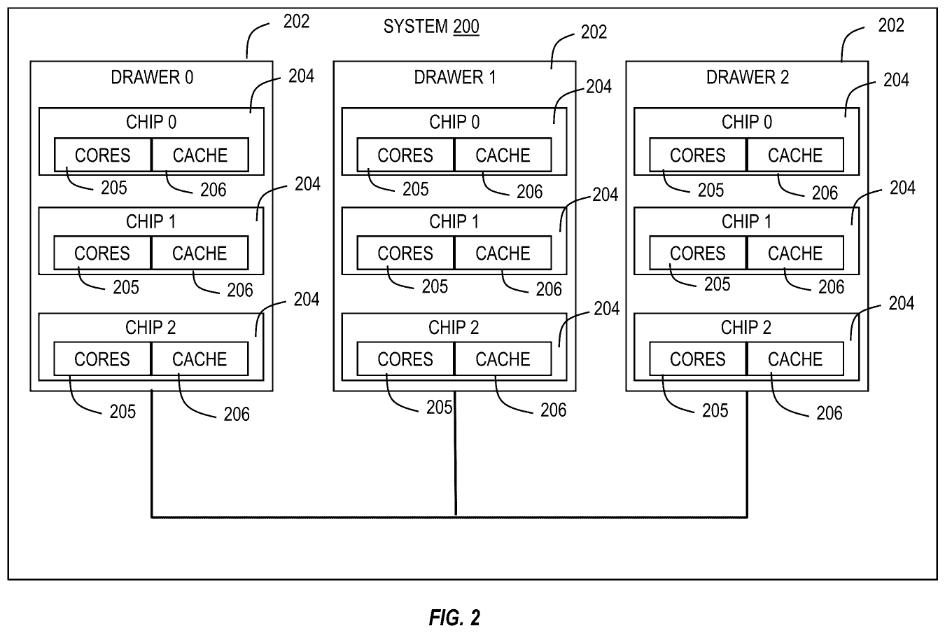

FIG. 2 depicts a block diagram of an example system 200 that includes multiple processor chips in a larger-scale architecture. In system 200, there can be many interconnected drawers 202, such as drawer 0, drawer 1, and drawer 2. Each of the drawers 202 includes processor chips 204, such as processor chip 0, processor chip 1, and processor chip 2. Each processor chip 204 includes two or more cores 205 and cache 206. The cache 206 can be implemented in a cache hierarchy where each of the cores 205 includes an L1 cache, and an L2 cache is shared between two or more of the cores 205. Lower levels of the cache 206 (e.g., level three (L3) caches) can be shared across the system 200. One or more processors 105 of FIG. 1 may represent processor chips 204. The processor chips 204 include processing circuitry, and the cache 206 can include memory and circuitry as understood by one of ordinary skill in the art. The system 200 can be implemented as a symmetric multiprocessing system, where coherency is maintained for shared resources, such as shared lines of the cache 206 within and across the drawers 202.

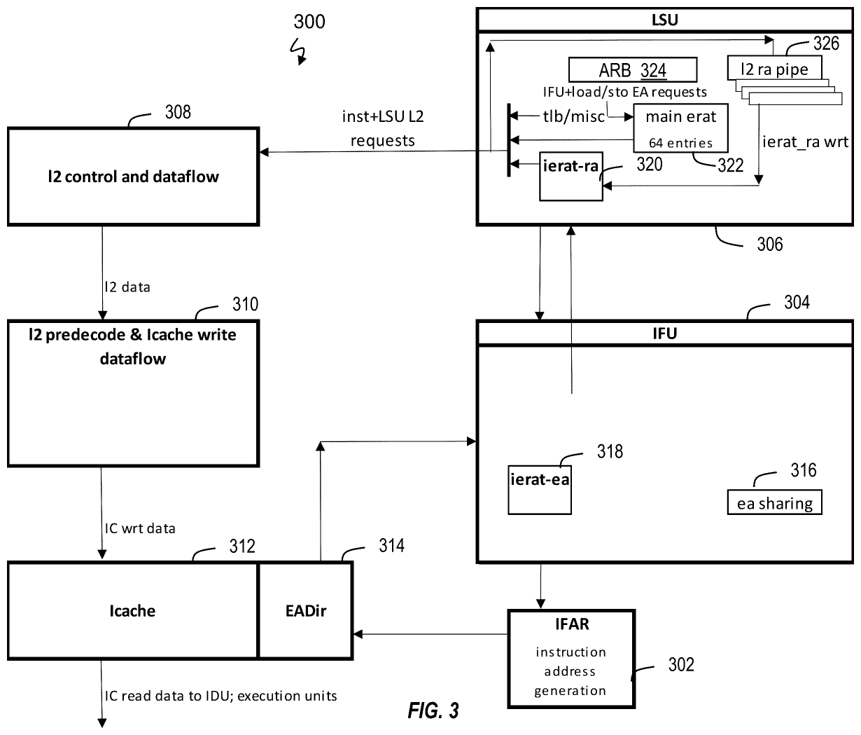

FIG. 3 depicts an example block diagram of a system 300 within a processor according to one or more embodiments. For example, the system 300 can be implemented within the processor 105 of FIG. 1 and/or in one or more cores 205 of the processor chips 204 of FIG. 2. The system 300 includes an instruction fetch address resolution (IFAR) unit 302, an IFU 304, and LSU 306, L2 control and dataflow 308, L2 predecode and I-cache write dataflow 310, and I-cache 312 with an effective address directory 314. In the context of addressing instructions in the I-cache 312, the IFAR 302 can perform instruction address generation and pass the result to the effective address directory 314 associated with the I-cache 312. In order to access a real address through the I-cache 312, a lookup process can be performed. Where the effective address directory 314 identifies that a hit is detected on an effective address basis, the IFU 304 can support effective address sharing 316 and manage an I-ERAT effective address portion 318. The IFU 304 can also interface with the LSU 306.

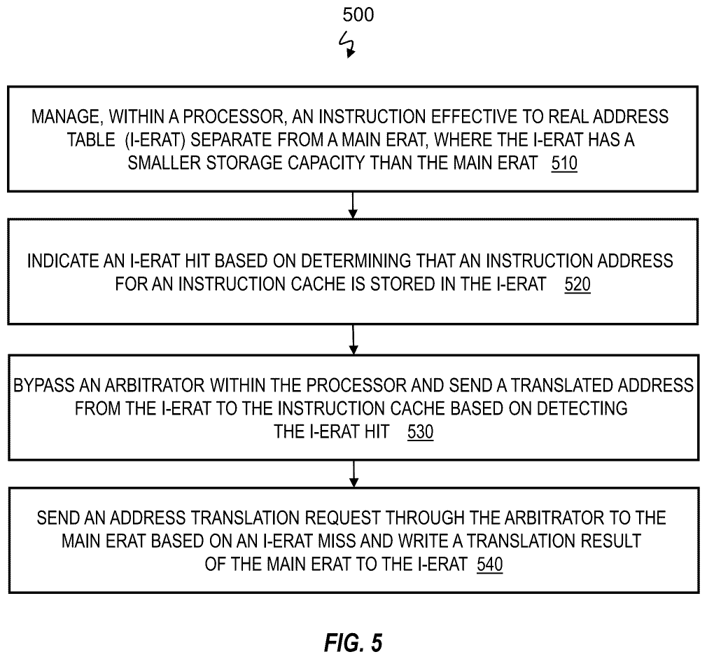

The LSU 306 can include an I-ERAT real address portion 320 that is associated with the I-ERAT effective address portion 318 to form a complete instance of the I-ERAT distributed across functional unit boundaries. The LSU 306 can also include a main ERAT 322, which can be accessed by multiple sources as arbitrated by an arbitrator 324. While the arbitrator 324 can act as a queue to prevent conflicts as multiple sources attempt to perform address translation through the main ERAT 322, the queuing of accesses to the main ERAT 322 can add delay cycles. As real addresses are determined through the main ERAT 322, translation results can be passed back through an L2 real-address pipeline 326 and provided to the I-ERAT real address portion 320 for storage. Translation results can be provided to the I-cache 312 through L2 control and dataflow 308 and L2 predecode and I-cache write dataflow 310 that can be configured to provide data, commands, and address signals as needed to the I-cache 312. For example, an address latch of the I-cache 312 can capture the translation results for use in selecting entries in the I-cache 312 for an instruction dispatch unit (IDU) and/or execution units. Circuitry of the system 300 can be configured to perform a method such as method 500 of FIG. 5. The circuitry can be in the form of latches, logic gates, and multiplexers for fast response times and to avoid delays associated with firmware execution to drive signal states and perform comparison operations. Timing can be controlled by connecting pipeline stages to specific subcircuits and signal paths.

Translation paths depicted in FIG. 3 can be used, for example, on an I-cache 312 miss request to an L2 cache. On misses of translations in the I-ERAT formed by the combination of the I-ERAT effective address portion 318 and the I-ERAT real address portion 320, a slower translation path through the arbitrator 324 and main ERAT 322 can be passed back through the L2 real-address pipeline 326 to the I-ERAT real address portion 320 and shared across functional units to the I-ERAT effective address portion 318. A subsequent translation that hits in the I-ERAT can provide a faster translation path through bypassing the arbitrator 324. In some embodiments, the I-ERAT can have about ⅛ to 1/16 as many entries as the main ERAT 322 to trade off speed for storage capacity, as the main ERAT 322 can provide translation services for other units and purposes.

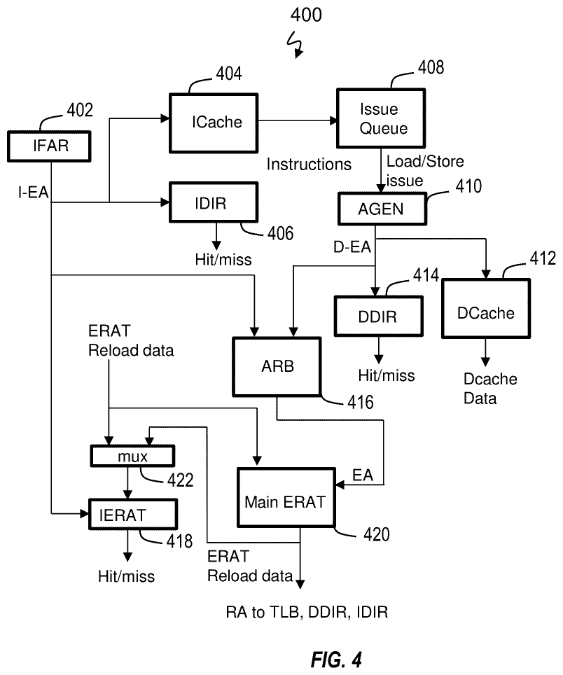

FIG. 4 depicts an example block diagram of a system 400 within a processor according to one or more embodiments. The system 400 is another example of an arrangement of components within a processor, such as the processor 105 of FIG. 1 and/or in one or more cores 205 of the processor chips 204 of FIG. 2 to support sideband instruction address translation. In the example of FIG. 4, an IFAR unit 402 can access an I-cache 404 and an I-cache directory (I-DIR) 406 to determine whether an instruction address has a hit or miss in the I-cache 404. Instructions from the I-cache 404 are passed to an issue queue 408. As load/store commands are issued, an address generator (AGEN) 410 can generate addresses for data values in an effective address format. To determine whether there is a hit or miss in a data cache (D-cache) 412, a D-cache directory (D-DIR) 414 can be accessed. The IFAR unit 402 and the AGEN 410 can perform address translation lookups through an arbitrator 416 to a main ERAT 420, which can output real addresses to a translation lookaside buffer, the I-DIR 406, and the D-DIR 414. The IFAR unit 402 can also check for translation hits and misses through an I-ERAT 418 that is smaller than the main ERAT 420. In some aspects, the main ERAT 420 can pass a translation result back to the I-ERAT 418 through a multiplexer 422. The multiplexer 422 can also be loaded with data to pass to the I-ERAT 418 and/or the main ERAT 420. Circuitry of the system 400 can be configured to perform a method such as method 500 of FIG. 5. The system 400 can use the faster path through the I-ERAT 418 and avoid the arbitrator 416 and main ERAT 420 when there is a hit in the I-ERAT 418 for an instruction address translation.

FIG. 5 is a flow diagram of a method 500 of sideband instruction translation, in accordance with one or more aspects of the disclosure. The method 500 may be performed by processing logic that may include hardware (e.g., circuitry, dedicated logic, programmable logic, a processor, a processing device, a central processing unit (CPU), a system-on-chip (SoC), etc.), firmware (e.g., microcode), or a combination thereof. Accordingly, FIG. 5 is described with reference to FIGS. 1-4.

With reference to FIG. 5, method 500 illustrates example functions used by various embodiments. Although specific function blocks (“blocks”) are disclosed in method 500, such blocks are examples. That is, embodiments can perform various other blocks or variations of the blocks recited in method 500. The blocks in method 500 may be performed in an order different than presented, and not all of the blocks in method 500 may be performed. Further, method 500 can be expanded to include additional steps beyond those depicted in the example of FIG. 5, and one or more blocks can be combined or further subdivided. Some blocks may be performed in parallel and continued in a pipelined implementation as address translation is needed for executing applications.

Method 500 begins at block 510. At block 510, an I-ERAT, such as I-ERAT 418 or distributed I-ERAT portions 318, 320 can be separately managed within a processor, such as circuitry of processor 105 or processor chips 204. At block 520, circuitry of the processor can indicate an I-ERAT hit based on determining that an instruction address for an instruction cache, such as I-cache 312, 404, is stored in the I-ERAT. At block 530, an arbitrator, such as arbitrator 324, 416, within the processor can be bypassed and a translated address can be sent from the I-ERAT to the instruction cache, such as I-cache 312, 404, based on detecting the I-ERAT hit. At block 540, an address translation request can be sent through the arbitrator, such as arbitrator 324, 416, to the main ERAT, such as main ERAT 322, 420, based on an I-ERAT miss, and a translation result of the main ERAT can be written to the I-ERAT.

In some aspects, the processor can include an IFU 110, 304 and an LSU 114, 306. The I-ERAT can be distributed between the IFU 110, 304 and LSU 114, 306 with effective addresses stored in the IFU 110, 304 (e.g., in I-ERAT effective address portion 318) and real addresses stored in the LSU 114, 306 (e.g., I-ERAT real address portion 320). The LSU 306 can also include the arbitrator 324 and the main ERAT 322. In some aspects, address translation through the I-ERAT 318/320, 418 can complete at least two cycles faster than through the arbitrator 324, 416 and the main ERAT 322, 420. In some aspects, the processor can be a multi-thread processor and address mapping through the I-ERAT can based on a number of threads. For example, where the I-ERAT is four entries, it can be allocated as four entries for one thread, two entry pairs for two threads, or four separate entries for four threads. In some aspects, bypassing of the arbitrator 324, 416 can be further based on determining that an arbitration cycle of the arbitrator 324, 416 is available. If the arbitrator 324, 416 is busy, then it is possible that an update to the main ERAT 322, 420 could be queued and I-ERAT data may be stale. Thus, for timing purposes and/or to ensure that I-ERAT data is current, a check of arbitration cycle availability can be another condition for using the faster path that skips the arbitrator 324, 416 and main ERAT 322, 420 on I-ERAT hits.

In some aspects, multiple page sizes can be handled through I-ERAT addressing, such as 4K and 64K page sizes. Further, benefits of speed ups can be delayed where an entry is not initially in the I-ERAT but is installed after a first miss. For example, a first pass through a loop of code may result in a 4-cycle period to perform arbitration and an ERAT lookup in the main ERAT, while a subsequent access to the I-ERAT can skip cycles for arbitration and main ERAT lookup, which can result in a 2-cycle period of time reduction. Depending on how code is structured and the amount of repetition, timing impact can vary. As one example, the IFU 304 may have a 4 cycle pipeline for receiving and passing address information to the LSU 306, and the LSU 306 may use either 2 or 4 pipeline stages for address translation depending on whether an I-ERAT hit is detected.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

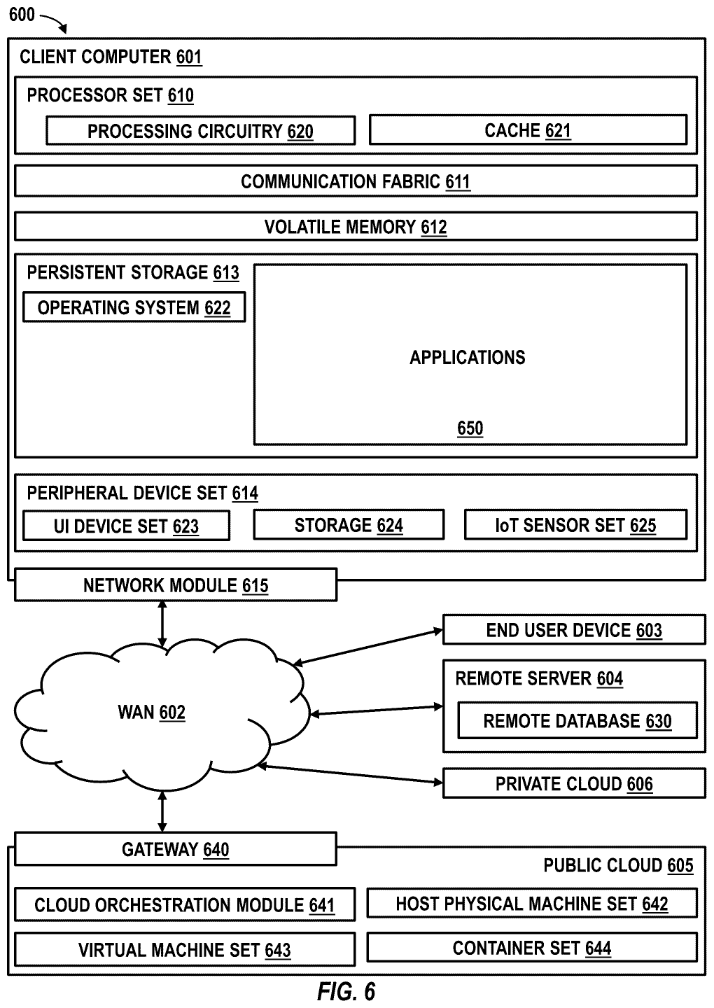

Computing environment 600 of FIG. 6 contains an example of an environment for the execution of at least some of the computer code involved in performing the inventive methods, such as applications 650 (also referred to as block 650) that may run using effective addresses but require address translation to real addresses. The computing environment 600 can include other aspects as previously described. Computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 650, as identified above), peripheral device set 614 (including user interface (UI), device set 623, storage 624, and Internet of Things (IOT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions using the inventive methods may be stored in block 650 in persistent storage 613.

COMMUNICATION FABRIC 611 is the signal conduction paths that allow the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface type operating systems that employ a kernel. The code included in block 650 typically includes at least some of the computer code involved in using the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
managing, within a processor, an instruction effective-to-real-address table (I-ERAT) separate from a main ERAT, wherein the I-ERAT has a smaller storage capacity than the main ERAT;
indicating an I-ERAT hit based on determining that an instruction address for an instruction cache is stored in the I-ERAT;
bypassing an arbitrator within the processor and sending a translated address from the I-ERAT to the instruction cache based on detecting the I-ERAT hit; and
sending an address translation request through the arbitrator to the main ERAT based on an I-ERAT miss and writing a translation result of the main ERAT to the I-ERAT.

2. The computer-implemented method of claim 1, wherein the processor comprises an instruction fetch unit (IFU) and a load store unit (LSU).

3. The computer-implemented method of claim 2, wherein the I-ERAT is distributed between the IFU and the LSU with effective addresses stored in the IFU and real addresses stored in the LSU.

4. The computer-implemented method of claim 3, wherein the LSU comprises the arbitrator and the main ERAT.

5. The computer-implemented method of claim 1, wherein address translation through the I-ERAT completes at least two cycles faster than through the arbitrator and the main ERAT.

6. The computer-implemented method of claim 1, wherein the processor is a multi-thread processor and address mapping through the I-ERAT is based on a number of threads.

7. The computer-implemented method of claim 1, wherein bypassing of the arbitrator is further based on determining that an arbitration cycle of the arbitrator is available.

8. A system of a processor comprising:
an instruction cache;
an arbitrator;
an instruction effective-to-real-address table (I-ERAT);
a main ERAT, wherein the I-ERAT has a smaller storage capacity than the main ERAT; and
circuitry configured to:
indicate an I-ERAT hit based on determining that an instruction address for the instruction cache is stored in the I-ERAT;
bypass the arbitrator and send a translated address from the I-ERAT to the instruction cache based on detecting the I-ERAT hit; and
send an address translation request through the arbitrator to the main ERAT based on an I-ERAT miss and write a translation result of the main ERAT to the I-ERAT.

9. The system of claim 8, further comprising an instruction fetch unit (IFU) and a load store unit (LSU).

10. The system of claim 9, wherein the I-ERAT is distributed between the IFU and the LSU with effective addresses stored in the IFU and real addresses stored in the LSU.

11. The system of claim 10, wherein the LSU comprises the arbitrator and the main ERAT.

12. The system of claim 8, wherein address translation through the I-ERAT completes at least two cycles faster than through the arbitrator and the main ERAT.

13. The system of claim 8, wherein the processor is a multi-thread processor and address mapping through the I-ERAT is based on a number of threads.

14. The system of claim 8, wherein bypassing of the arbitrator is further based on determining that an arbitration cycle of the arbitrator is available.

15. A computer program product comprising a computer readable storage medium having program instructions embodied therewith, the program instructions executable by one or more processors to cause the one or more processors to perform operations comprising:
storing a plurality of address translations within an instruction effective-to-real-address table (I-ERAT) and a main ERAT, wherein the I-ERAT has a smaller storage capacity than the main ERAT;
indicating an I-ERAT hit based on determining that an instruction address for an instruction cache is stored in the I-ERAT;
bypassing an arbitrator within the one or more processors and sending a translated address from the I-ERAT to the instruction cache based on detecting the I-ERAT hit; and
sending an address translation request through the arbitrator to the main ERAT based on an I-ERAT miss and writing a translation result of the main ERAT to the I-ERAT.

16. The computer program product of claim 15, wherein the one or more processors comprise an instruction fetch unit (IFU) and a load store unit (LSU).

17. The computer program product of claim 16, wherein the I-ERAT is distributed between the IFU and the LSU with effective addresses stored in the IFU and real addresses stored in the LSU.

18. The computer program product of claim 17, wherein the LSU comprises the arbitrator and the main ERAT.

19. The computer program product of claim 15, wherein address translation through the I-ERAT completes at least two cycles faster than through the arbitrator and the main ERAT.

20. The computer program product of claim 15, wherein at least one of the one or more processors is a multi-thread processor and address mapping through the I-ERAT is based on a number of threads.
